(19) United States
(12) Patent Application Publication
(10) Pub. No.: US 2008/0271736 A1
(43) Pub. Date: Nov. 6, 2008

(54) Wireless veterinary anesthesia monitoring system

(75) Inventors: Robert Dean Leonard, Fallbrook, CA (US); Daniel Brosler, Corona, CA (US)

Correspondence Address: CR MILES, P.C.;CRAIG R. MILES, 405 MASON COURT, SUITE 119, FORT COLLINS, CO, 80524, US

(73) Assignee: CDR Medical, LLC

(21) Appl. No.: 12/151,100

(22) Filed: May 2, 2008

Related U.S. Application Data
(60) Provisional application No. 60/927,600, filed on May 4, 2007.

(51) Int. Cl. A61D 7/04; A61D 99/00

(52) U.S. Cl. 128/203.12; 600/301

(57) ABSTRACT

A wireless veterinary anesthesia monitoring system which provides a wireless anesthesia monitoring platform configured to locate veterinary anesthesia equipment and wireless veterinary surgical monitoring equipment in a single constructional form useful in the anesthesia and surgical monitoring of animals.

### I. BACKGROUND

A wireless veterinary anesthesia monitoring system which provides a wireless anesthesia monitoring station configured to locate veterinary anesthesia equipment and wireless veterinary surgical monitoring equipment in a single constructional form useful in the anesthesia and surgical monitoring of animals.

A significant problem with conventional anesthesia delivery and surgical monitoring can be that the anesthesia equipment and the surgical monitoring equipment can comprise a plurality of individual devices or parts of such devices which by way of conventional practice or due to the configuration of each device or part thereof establish the corresponding display portion (that portion which includes certain visual indicia which vary in accordance with change in a measured parameter) at locations disparate from one another. One aspect of this problem can be that surgical monitoring devices which measure certain biological functions of an animal such as heart rate, blood pressure, blood gases, respiration, body temperature, and the like, are hard wired between the signal generation portion of each device engaged with a part of an animal and the display portion of each device. Because the location of the display portion of each device must be located at a distance not greater than the length of the hard wire, each of several displays may have a different location.

A second aspect of this problem can be that anesthesia equipment which delivers an amount of anesthetic to the animal before and during a surgical procedure may have the display portion which provides visual indicia (or other auditory or tactile indicia) relating to the performance of the anesthesia equipment located separate from the display portion of the surgical monitoring devices which provide visual indicia relating to a measure of one or more of the above-described biological functions of the animal. Another aspect of this problem can be that each anesthesia device or each surgical monitoring device requires a surface means differently configured to allow securement of each device or the display portion of each device. Moreover, the peripheral materials utilized with such anesthesia equipment and surgical monitoring equipment may be located at yet different locations.

To address the unresolved problems associated with the utilization of conventional anesthesia equipment and surgical monitoring equipment the instant inventive wireless anesthesia monitoring system provides a wireless anesthesia monitoring station having a surface configured to locate the display portion of veterinary anesthesia equipment and wireless veterinary anesthesia monitoring equipment in close proximity.

### II. SUMMARY OF THE INVENTION

Accordingly, a broad object of the invention can be to provide wireless veterinary anesthesia monitoring system which in part provides a wireless anesthesia monitoring station configured to locate veterinary anesthesia equipment and wireless veterinary surgical monitoring equipment in a single constructional form useful in the anesthesia and surgical monitoring of animals.

Naturally, further objects of the invention are disclosed throughout other areas of the specification, drawings, photographs, and claims.

### III. A BRIEF DESCRIPTION OF THE DRAWINGS

FIG. 1 is a perspective view of an embodiment of the wireless veterinary monitoring system.

FIG. 2 is a plan view of an embodiment of the wireless veterinary monitoring system.

FIG. 3 is a front view of an embodiment of the wireless veterinary monitoring system.

FIG. 4 is a side view of an embodiment of the wireless veterinary monitoring system.

FIG. 5 is a block diagram of hardware means, software means, signal transmission and receiving means which may be utilized to practice particular embodiments of the invention.

### IV. DETAILED DESCRIPTION OF THE PREFERRED EMBODIMENTS

Accordingly, the shortcomings of conventional anesthesia equipment and surgical monitoring equipment are addressed by providing wireless anesthesia monitoring station having a surface configured to secure veterinary anesthesia delivery equipment and wireless veterinary surgical monitoring equipment useful in anesthesia delivery and surgical monitoring of animals and method of using the mobile platform to secure veterinary anesthesia delivery equipment and wireless surgical monitoring equipment useful in anesthesia delivery and surgical monitoring of animals.

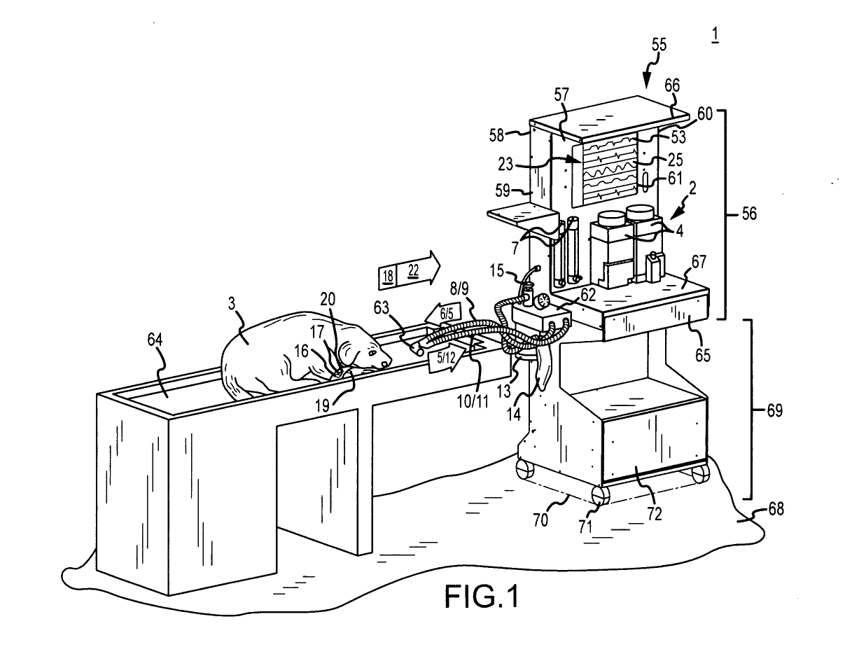

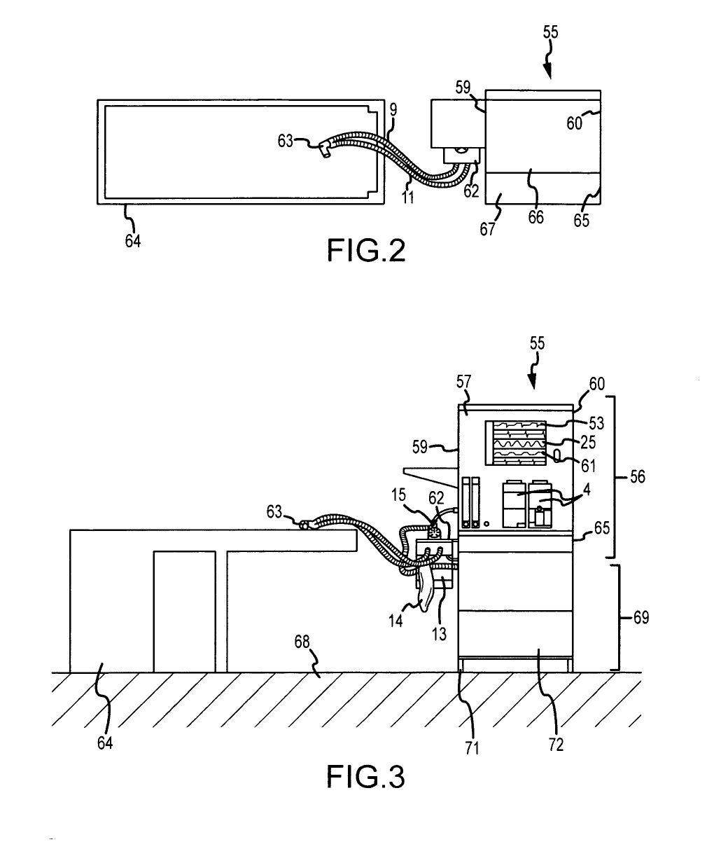

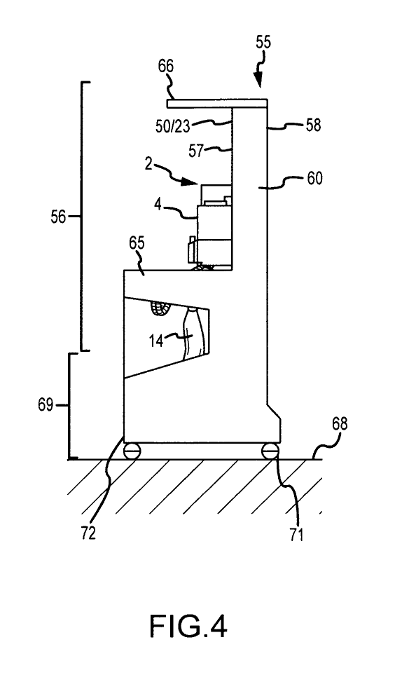

Now referring to FIGS. 1-4, the inventive wireless veterinary anesthesia monitoring system (1) can provide veterinary anesthesia delivery equipment (2) utilized to anesthetize an animal (3). An example of veterinary anesthesia delivery equipment (2) can for example include a vaporizer (4) (or other type of anesthetic source) from which an amount of anesthetic such as Isoflurane, Sevflurane, Enflurane, Halothane, Desflurane, or the like, can be delivered to the animal (3). The embodiment of the inventive wireless veterinary anesthesia monitoring system (1) shown by FIG. 1 provides two vaporizers (4) (although a fewer or greater number could be provided) each configured to deliver an amount of anesthetic (5) of different composition. A flow of gas (6) (or a flow of gases) can be generated from a gas container (not shown) which can be air or a mixture of gases having selected partial pressures that can be introduced into each or both vaporizer(s) (4) through a corresponding gas flow regulation valve (7). The amount of anesthetic (5) can be entrained in the flow of gas (6) by the vaporizer (4) and directed into the flow path of an inhalation circuit (8) of an inhalation conduit (9) which allows delivery of the amount of anesthetic (5) entrained in the flow of gas (6) to the animal (3). The inhaled flow of gas (6) entraining the amount of anesthetic (5) can be inhaled by the animal (3). A portion of the inhaled anesthetic (5) can enter the bloodstream of the animal (3). A portion of the amount of anesthetic (5) may not enter the blood stream of the animal (3) and may be exhaled into the exhalation circuit (10) of an exhalation conduit (11). The exhaled mixture gases (12) and the remaining portion of the amount of anesthetic (5) may be transferred to a carbon dioxide absorber (13) and the carbon dioxide in the exhaled mixture of gases (12) may be transferred to a carbon dioxide absorbent contained within the carbon dioxide absorber (13). The resulting mixture of gases may return to the inhalation circuit (8) and an additional amount of anesthetic (5) may be entrained into the flow of gas(es) (6) in the inhalation circuit (8). A flexible breathing bag (14) may accommodate the respiratory volume of the animal (3). The partial pressure of oxygen in the flow of gas(es) (6) in the inhalation circuit (8) may be adjusted by introduction of oxygen through an oxygen flow regulation valve (15). A pressure relief valve (not shown) may provide release of the flow of gases (6) from the inhalation and exhalation circuits (8)(10) to maintain the desired gas pressure within each of the circuits (8)(10).

The inventive wireless veterinary anesthesia monitoring system (1) can further provide at least one physiological sensor (16) responsively engaged to the animal (3). Each physiological sensor (16) provides a signal generator (17) which can generate a signal (18) which varies based upon a sensed physiological characteristic (19) of the animal (3). The physiological sensor (16) and the sensed physiological characteristic (19) can include for example: a blood pressure cuff (as shown by the non-limiting example of FIG. 1) which can sense blood pressure and generate a corresponding blood pressure signal, an oral probe which can sense respiratory airway gas mixture and generate a corresponding one or more gas concentration signal(s), a rectal probe which can sense rectal temperature and generate a corresponding temperature signal, a transesophageal probe which can sense heart rate and heart function and generate corresponding heart rate and heart function signals, a stethoscope which can sense blood flow and generate a corresponding blood flow signal, or the like. Certain physiological sensor(s) (16) suitable for use with the wireless veterinary anesthesia monitoring system (1) can be obtained from Vmed Technology, Inc., 16149 Redmond Way, #108, Redmond, Wash. 98052. A signal transmitter (20) (such as a radio frequency transmitter) can be coupled to each physiological sensor (16) allowing data corresponding to each sensed physiological characteristic (19) of the animal (3) to be wirelessly transmitted (22) within the range of the signal transmitter (20) and a corresponding signal receiver (21), further described below.

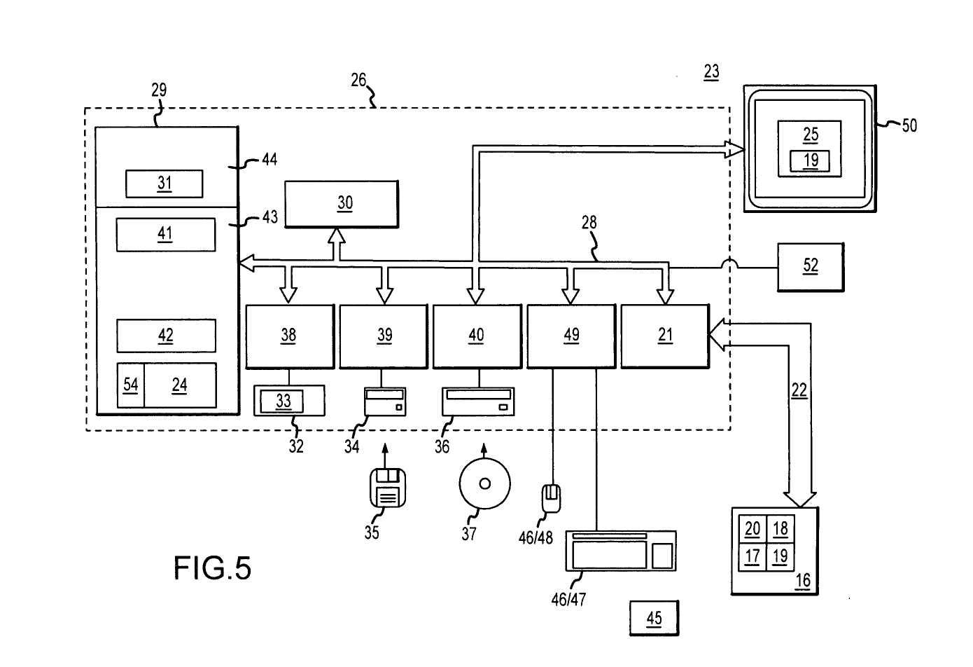

Now referring primarily to FIG. 5, the inventive wireless veterinary anesthesia monitoring system (1) can further provide a portable monitor (23). The portable monitor (23) in part can provide a signal receiver (21) capable of receiving the wireless transmission (22) of the signal (18) corresponding to one or more sensed physiological characteristic (19) of the animal (3). The signal receiver (21) can be configured to receive short-range wireless transmissions or communications from the signal transmitter (20) of the physiological sensor (16) responsive to the animal (3) allowing conventional cables associated with the conventional sensors hardwired to a monitoring devices to be eliminated. For example, the portable monitor (23) can include as the signal receiver (21) a radio frequency receiver which as to certain embodiments of the invention can receive a wireless transmission (22) in the form of a radio frequency in the unlicensed ISM band at 2.4 GHz. The portable monitor (23) can further provide a frequency hop transceiver to combat interference and fading which utilizes a plurality of carriers. The radio frequency operation can use a shaped, binary frequency modulation with a symbol rate of about 1 megasymbol per second to support a bit rate of 1 megabit per second or a gross air bit rate of about 2 or 3 Mb/s. A plurality of physiological sensors (16) (generically encompassed by the block shown in FIGS. 1 and 5) can be monitored concurrently by synchronizing each to a common clock and frequency hopping pattern. As an example, the portable monitor (23) can utilize the BLUETOOTH® connectivity standard to monitor a plurality of wirelessly transmitted (22) signals (18) from a plurality of physiological sensors (16).

The portable monitor (23) can further include computer implemented signal analyzer (24) coupled to the signal receiver (21) which functions to continuously convert the signal (18) into a viewable data representation (25) of the sensed physiological characteristic (19) of the animal (3). The computer implemented signal analyzer (24) includes a computer (26) capable of delivering instructions for the analysis of one or more signals (18) wirelessly transmitted (22) to the signal receiver (21) corresponding to one or more of the sensed physiological characteristics (19) of the animal (3). The computer (26) can include a processing unit (27) which without limitation can provide one central-processing unit (CPU), or a plurality of processing units which operate in parallel to process digital information. A bus (28) which operably couples components of computer (26), including, without limitation a memory element (29) to the processing unit (30). The bus (28) can be without limitation any of several types of bus configurations such as a memory bus or memory controller, a peripheral bus, and a local bus using any of a variety of bus architectures. The memory element (29) can without limitation be a read only memory (ROM), or a random access memory (RAM), or both. A basic input/output system (BIOS) (31), containing routines that assist transfer of data between the components of the computer (26), for example during start-up, can be stored in ROM. The computer (26) can further include a hard disk drive (32) for reading from and writing to a hard disk (33), a magnetic disk drive (34) for reading from or writing to a removable magnetic disk (35), an optical disk drive (36) for reading from or writing to a removable optical disk (37) such as a CD ROM, or other optical media.

The hard disk drive (32), magnetic disk drive (34), and optical disk drive (367) can be connected to the bus (28) by a hard disk drive interface (38), a magnetic disk drive interface (39), and an optical disk drive interface (40), respectively. The drives and their associated computer-readable media provide nonvolatile storage of computer-readable instructions, data structures, program modules and other data of the computer (26). It can be appreciated by those skilled in the art that any type of computer-readable media that can store data that is accessible by the computer (26), such as magnetic cassettes, flash memory cards, digital video disks, Bernoulli cartridges, random access memories (RAMs), read only memories (ROMs), and the like, may be provided by the computer (26) used in embodiments of the inventive wireless veterinary anesthesia monitoring system (1).

The computer (26) can further include an operating system (41) and a signal analysis application (42) which may be stored on or in the hard disk (33), magnetic disk (35), optical disk (37), ROM (43), in RAM (44) by a particular embodiment of a first computer (26). A computer user (45) can enter commands and information into the computer (26) through one or more command input device(s) (46) such as a keyboard (47) and pointing device such as a mouse (48). Other command input devices (46) can include a microphone, joystick, game pad, scanner, or the like. These and other command input device(s) (46) are often connected to the processing unit (30) through a serial port interface (49) that can be coupled to the bus (28), but may be connected by other interfaces, such as a parallel port, game port, or a universal serial bus (USB). A viewer (50) (for example a computer monitor or other type of display device) can also be connected to the bus (28) via interfaces such as a video adapter (51), or the like. In addition to the viewer (50), the first computer (26) can further include other peripheral output devices (52), such as speakers and printers.

Again referring primarily to FIG. 5, the computer (26), the signal analyzer (24) and signal analysis application (42) can in part function to analyze the wireless transmission (22) of the signal(s) (18) corresponding to one or more sensed physiological characteristic (19) to intermittently or continuously convert the signals (18) into a viewable data representation (25) of the sensed physiological characteristic (19). The viewable data representation (25) can be continuously or intermittently displayed on the viewer or updated upon elapse of a short interval of time such as 100 milliseconds. For the purposes of this invention the term “viewable data representation” means an intermittently updated graphical display of: viewable waveforms (53) (for example waveform representations of heart rate or heart function); plots of the concentration of certain gases (such as respired oxygen concentration, respired carbon dioxide concentration, or the like); and alpha data types and numeric data types which continuously update to allow integer values to be assigned to temperature, blood pressure, blood oxygen concentration percent, blood carbon dioxide concentration percent, respired anesthetic concentration percent, or the like. Each signal (18) generated by the signal generator (17) of each physiological sensor (16) can be converted from analog to digital signals by an analog to digital converter (54) included as part of the signal analyzer (24). A non-limiting example of a software application which can be utilized with certain embodiments of the invention to convert the wirelessly transmitted (22) plurality of signals (18) corresponding to one or more sensed physiological characteristics (19) to a viewable data representation (25) can be obtained from Vmed Technology, Inc., 16149 Redmond Way, #108, Redmond, Wash. 98052. The viewer (50) can be coupled to the signal analyzer (24) allowing the viewable data representation (25) to be provided as a graphical display for viewing.

Again referring to FIGS. 1-4, the wireless veterinary anesthesia system (1) can further include a wireless anesthesia monitoring station (55) having a surface configured to secure the veterinary anesthesia delivery equipment (2) and portable monitor (23) above described. The wireless anesthesia monitoring station (55) can provide a vertical tower portion (56) which provides a front panel (57) and a back panel (58) typically of rectangular geometry held a distance apart in substantially parallel opposition by joined side panels (59)(60). The tower portion (56) typically has a greater height than width and the joined side panels (59)(60) establish sufficient depth to generate an inside space sufficiently large to receive the portable monitor (23) and a gas container (not shown) from which the flow of gas(es) (6) can be generated. The front panel (57) can further provide a display screen aperture (61). The viewer (50) of the portable monitor (23) can engage the inside surface of the front panel (57) at a location which allows the viewer (50) of the portable monitor (23) to be viewed through the display screen aperture (61) of the front panel (57) of the vertical tower portion (56). The front panel (57) of the tower portion (56) can be of sufficient height to locate the display screen aperture (61) between about thirty inches and seventy two inches above the support surface.

The outside surface of the front panel (57) below the display screen aperture (61) has a configuration sufficiently large to allow fixed engagement of the vaporizer (4) or a plurality of vaporizers along with the corresponding flow regulation valve (7) to the front panel (57). An inhalation circuit and exhalation circuit assembly (62) which functions to direct the flow of gases (6) in the inhalation circuit (8) and the exhalation circuit (10) can be coupled to the vertical tower portion (56) at a height sufficient to locate an animal airway adaptor (63) proximate to the animal (3) supported on surface of a veterinary table (64).

The vertical tower portion (56) can further provide at least one projection element (65)(66). In the embodiment of the invention shown in the Figures, a first projection element (65) can extend outwardly from the front panel (57) to establish a first projection surface (66) a distance above the support surface below the height of the display screen aperture (26). The first projection surface (67) can be established in substantially parallel relation to the support surface (68) (such as a floor or a table surface). A second projection element (66) can extend outwardly from the front panel (57) at a height above the display screen aperture (61) which functions to reduce ambient light at the location of the viewer (50).

The wireless anesthesia monitoring station (55) can further include a base portion (69). The base portion (69) of the wireless anesthesia monitoring station (55) has a configuration which joins the vertical tower portion (56) and engages the support surface (68) with a foot print (70) sufficiently large to maintain the vertical tower portion (56) in substantially perpendicular relation to the support surface (68) during normal anesthesia and surgical monitoring events. The base portion (69) can further provide rotatable elements (71) which facilitate travel of the wireless anesthesia monitoring station (55) on the support surface (68). The base portion (692) can be of sufficient height to provide an accessible inside space (72) in which materials useful in the anesthesia and surgical monitoring of the animal (3) can be located. As to the embodiment of the invention shown in the Figures, the an accessible inside space (72) comprises a drawer which extendably retractably inserts into the base portion (69) of the monitoring station (55).

As can be easily understood from the foregoing, the basic concepts of the present invention may be embodied in a variety of ways. The invention involves numerous and varied embodiments of wireless veterinary anesthesia monitoring system and methods of making and using such wireless veterinary anesthesia monitoring system. As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “monitor” should be understood to encompass disclosure of the act of “monitoring”—whether explicitly discussed or not—and, conversely, were there effectively disclosure of the act of “monitoring”, such a disclosure should be understood to encompass disclosure of a “monitor” and even a “means for monitoring.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Thus, the applicant(s) should be understood to claim at least: i) each of the wireless veterinary anesthesia monitoring systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof or to obtain any benefit of reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below, if any, are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

We claim:

1. An anesthesia device, comprising:
a) an anesthetic source which contains an anesthetic;
b) a flow of gas which entrains an amount of said anesthetic contained in said anesthetic source;
c) an inhalation circuit coupled to said anesthetic source which provides a flow path to deliver said amount of said anesthetic entrained in said flow of gas to an animal for inhalation;
d) an exhalation circuit which receives an mixture of gases exhaled by said animal;
e) a physiological sensor coupled to said animal, wherein said physiological sensor provides a signal generator generates which generates a signal which corresponds to a sensed physiological characteristic of said animal;
f) a signal transmitter coupled to said physiological sensor capable of wireless transmission of said signal; and
g) a portable monitor which includes:
i) a signal receiver capable of receiving wireless transmission of said signal;
ii) a computer implemented signal analyzer coupled to said signal receiver which functions to continuously convert said signal into a viewable data representation of said sensed physiological characteristic of said animal; and
iii) a viewer coupled to said signal analyzer on which said viewable data representation of said sensed physiological characteristic of said animal can be viewed.

2. The anesthesia device as described in claim 1, wherein said physiological sensor coupled to said animal which provides a signal generator which generates a signal which corresponds to a sensed physiological characteristic of said animal comprises a plurality of physiological sensors discretely coupled to said animal which provide a corresponding plurality of signal generators which generate a corresponding plurality of signals which correspond to a plurality of sensed physiological characteristics.

3. The anesthesia device as described in claim 2, wherein said portable monitor includes a signal receiver capable of receiving wireless transmission of said plurality of signals, and wherein said computer implemented signal analyzer coupled to said signal receiver functions to continuously convert said plurality of signals into a corresponding plurality of viewable data representations which can be viewed as coincident events on said viewer.

4. The anesthesia device as described in claim 3, further comprising a wireless monitoring station configured to receive said portable monitor.

5. The anesthesia device as described in claim 4, wherein said wireless monitoring station has a configuration allows secured engagement of said anesthetic source which contains said anesthetic.

6. The anesthesia device as described in claim 5, further comprising rotatable elements coupled to said wireless monitoring station which allows said wireless monitoring station to travel on a support surface.

7. A method of anesthesia, comprising the steps of:
a) providing an anesthetic source containing an amount of anesthetic;
b) entraining an amount of said anesthetic in a flow of gas;
c) inhaling said amount of anesthetic entrained in said flow of gas by an animal coupled to an inhalation circuit having a flow path coupled to said anesthetic source;
d) exhaling a mixture of gases by said animal to an exhalation circuit;
e) coupling at least one physiological sensor to said animal inhaling said amount of anesthetic;
f) sensing a physiological characteristic of said animal inhaling said amount of anesthetic;
g) generating a signal which corresponds to a sensed physiological characteristic;
h) wirelessly transmitting said signal which corresponds to said sensed physiological characteristic; and
i) providing a portable monitor which functions to provide the steps of:
i) wirelessly receiving said signal which corresponds to said sensed physiological characteristic;
ii) analyzing said signal to generate a viewable data representation of said sensed physiological characteristic; and
iii) displaying said viewable data representation on a viewer.

8. The method of anesthesia as described in claim 7, wherein said step of sensing a physiological characteristic of said animal inhaling said amount of anesthetic comprises the step of sensing a plurality of physiological characteristics of said animal inhaling said amount of anesthetic.

9. The method of anesthesia as described in claim 8, wherein said step of generating a signal which corresponds to a sensed physiological characteristic comprises the step of generating a plurality of signals corresponding to a plurality of sensed physiological characteristics.

10. The method of anesthesia as described in claim 9, wherein said step of wirelessly transmitting said signal which corresponds to said sensed physiological characteristic comprises the step of wirelessly transmitting said plurality of signals which correspond to said plurality of sensed physiological characteristics.

11. The method of anesthesia as described in claim 10, wherein said steps of providing a portable monitor which functions to provide the steps of:
i) wirelessly receiving said signal which corresponds to said sensed physiological characteristic;
ii) analyzing said signal to generate a viewable data representation of said sensed physiological characteristic;
iii) displaying said viewable data representation on a viewer;
comprises the steps of:
i) wirelessly receiving said plurality of signals which correspond to said plurality of sensed physiological characteristics;
ii) analyzing said plurality of signals to generate a plurality of viewable data representations of said plurality of sensed physiological characteristics; and
iii) displaying said plurality of viewable data representation as coincident events on a viewer.

12. The method of anesthesia as described in claim 11, further comprising the step of providing a wireless monitoring station to which said portable monitor secures at a location which allows said viewer to be viewed through a display screen aperture.

13. The method of anesthesia as described in claim 12, further comprising the step of securing said anesthetic source to said wireless monitoring station.

14. The method of anesthesia as described in claim 12, further comprising the step of coupling rotatable element to said wireless monitoring station which allows said wireless monitoring station to travel on a support surface.
